(19) United States
(12) Patent Application Publication
(10) Pub. No.: US 2025/0124514 A1
(43) Pub. Date: Apr. 17, 2025

(54) SYSTEMS AND METHODS FOR OPTIMIZING USER INTERACTION FOR INSURANCE ENROLLMENTS

(71) Applicant: FBMC Benefits Management, Inc., Tallahassee, FL (US)

(72) Inventors: David Perry, JR., McKinney, TX (US); Richard Farris, Tallahassee, FL (US); Millard Wetzel, Tallahassee, FL (US)

(21) Appl. No.: 18/912,193

(22) Filed: Oct. 10, 2024

Related U.S. Application Data
(60) Provisional application No. 63/543,715, filed on Oct. 11, 2023.

(51) Int. Cl. G06Q 40/08

(52) U.S. Cl. CPC G06Q 40/08

(57) ABSTRACT

A computer-implemented system and method are provided. The system and method analyze GIS data and transform the analyzed GIS data based on one or more additional weighted variables into transformed data predictive of optimal locations for one or more enrollers to service and predictive of optimal staffing of enrollments for reducing or minimizing costs while at the same time increasing or maximizing awareness and appropriate utilization of insurance products to thereby boost employee enrollment in various products and/or particular products.

### INCORPORATION BY REFERENCE TO RELATED APPLICATION

This application claims the benefit of U.S. Provisional Application No. 63/543,715 filed Oct. 11, 2023. The entire contents of this application is incorporated herein by reference in its entirety.

### FIELD OF THE INVENTION

The present invention is directed to a system for and method of optimizing user interaction for insurance enrollments, and more particularly, to a system for and method of predicting optimal locations for one or more enrollers to service and predicting optimal staffing of enrollments for reducing or minimizing costs while at the same time increasing or maximizing education, awareness, and appropriate utilization of insurance products to thereby boost employee enrollment in various products and/or particular products.

### BACKGROUND OF THE INVENTION

Some companies, such as an insurance agency, provide brokerage and enrollment services to clients, who are employer-sponsors of group and individual life and health insurance coverages. The company may manage the open enrollments for large clients (e.g., school districts, hospitals, etc.) that may have different locations across a geographical area. To provide this service to clients, the company may hire licensed, independent contractors (i.e., enrollers) to meet with employees of clients at one or more different locations within the geographic area of the client.

### SUMMARY OF THE INVENTION

The present invention recognizes that some of the enrollment services being provided by a company may be substantially large and require servicing, for example, 30,000 employees of a company's clients utilizing 30-40 contracted enrollers at 15-30 different locations across a substantial geographic area. While the enrollers may be paid a flat rate (i.e., no commissions), a company may incur substantial costs associated with the enrollers servicing the company's clients at different locations across the geographic area, such as travel costs in time, distance, etc. Therefore, the present invention recognizes that there is a need to identify and predict ways to minimize a company's costs associated with the enrollers. Moreover, the present invention recognizes that, while it is critical to identify and predict ways to minimize costs associated with enrollers, it also is critical, at the same time, to increase or maximize education, awareness, and appropriate utilization of insurance products by employees of the company's clients at different locations across the geographic area to thereby boost employee enrollment in various products and/or particular products.

To solve these and other problems, the exemplary embodiments of the present invention provide systems for, and methods of, optimizing user interaction for insurance enrollments, and more particularly, predicting optimal locations for one or more enrollers to service and predicting optimal staffing of the enrollments. In this way, the present invention not only can reduce or minimize costs associated with enrollers, but also can increase or maximize awareness and appropriate utilization of insurance products, for example, by identifying gaps and opportunities in a company's approach to designing or enhancing benefit programs, executing engagement campaigns, and/or providing overall education and awareness of the insurance products for educating employees of a client about the benefit(s) available and/or how to better utilize the benefits, among other things, to thereby boost employee enrollment in various products and/or particular products.

According to the exemplary aspects of the invention, GIS (geographic information systems) technology can be utilized and analyzed based on one or more additional weighted variables to identify one or more optimal locations (e.g., facilities) for one or more enrollers to service the largest populations for in-person consultations in the most efficient way, thereby reducing or minimizing costs, while at the same time increasing or maximizing awareness and appropriate utilization of insurance products including, for example, by identifying gaps and opportunities in a company's approach to designing or enhancing benefit programs, executing engagement campaigns, and/or providing overall education and awareness of the insurance products for educating employees of a client about the benefit(s) available and/or how to better utilize the benefits, among other things, to thereby boost employee enrollment in various products and/or particular products.

In an example, the system can be configured to receive GIS data, and more particularly, to receive GIS data utilizing publicly available, subscription-based GIS tools. The system can be configured to analyze the GIS data and then transform the analyzed GIS data based on one or more additional weighted variables into transformed data predictive of optimal locations for one or more enrollers to service and optimal staffing of enrollments while reducing or minimizing costs and increasing or maximizing revenue from commissions on the insurance sales. The exemplary system can be configured to utilize geoprocessing and network analysis capabilities to analyze the GIS data including, for example, analyzing and modeling transportation networks, such as road networks, and calculating transportation times, such as drive times, for enrollers from an employee's home address to one or more facilities, between one or more facilities, etc. The system can be configured to transform the analyzed GIS data based on additional weighted variables, such as a capacity of a location or facility, priority of a location or facility, the demand at a location or facility (e.g., historic demand), demographics, employee engagement levels relative to one or more locations, and/or other weighted variables, into transformed data predictive of optimal locations for one or more enrollers to service and optimal staffing of enrollments while reducing or minimizing costs and, at the same time, increasing or maximizing awareness and appropriate utilization of insurance products including, for example, identifying gaps and opportunities in a company's approach to designing or enhancing benefit programs, executing engagement campaigns, and/or providing overall education and awareness of the insurance products for educating employees of a client about the benefit(s) available and/or how to better utilize the benefits, among other things, to thereby boost employee enrollment in various products and/or particular products. The exemplary embodiments of the invention can transform the analyzed GIS data based on the additional weighted variables to train a machine learning algorithm and provide customized recommendations and predictions to a customer (employer—sponsors, or other insurance brokers) based on the customer's unique data, including for example age, salary, position, geography, and available products. According to the exemplary embodiments, in addition to providing recommendations for grouping enrollers based on drive times, the exemplary system can identify optimal facilities for in-person consultations and provide more strategic and cost-effective enroller location recommendations, enhance the efficiency of in-person open enrollment meetings, identify gaps and opportunities in a company's approach to designing or enhancing benefit programs, execute engagement campaigns, and/or provide overall education and awareness of the insurance products for educating employees of a client about the benefit(s) available and/or how to better utilize the benefits, and ultimately boost employee enrollment in various products and/or particular products based on one or more additional weighted variables.

By transforming the analyzed GIS data utilizing, for example, predictive modeling and real-time data analysis in combination with additional weighted variables utilizing historical knowledge, expertise, and archive data, the exemplary system can output relevant, accurate, and highly effective recommendations and predictions for product offerings, quantities, design, and forecasted utilization, among other things. The exemplary system can identify and/or rank one or more facilities, for example, by priority or importance, and/or as a candidate facility or as a required facility for in-person enrollment. In other exemplary embodiments, the system can utilize ChatGPT or other generative AI technologies to develop and provide customized recommendations to customers based on the outputs, including rankings and/or categories of such recommendations.

The weighted variables can include, for example, demographic data, engagement data, and/or regional data, etc. For example, the demographic data can include key demographic data for a particular region, density, etc., the engagement data can include engagement metrics such as historical engagement metrics, and the regional data can include population density data. For example, the data may represent that a particular location has employees in a certain age range that historically enrolls in a certain product. The data also may represent historical engagement levels (i.e., enrollment attendance, enrollments per product line/category, open and click rates on email and text message communications).

The system can be configured to transform the analyzed GIS data based on the additional weighted variables, such as demographics, engagement levels, and/or regional data into transformed data predictive of, for example, optimal locations where enrollments should take place, for how long, how many enrollers per location, and which products to promote or not, among other things. The transformed data can be input into, or utilized by, a scheduling tool to further predict or recommend a date and/or time of day of enrollments. Based on the additional weighted variables, the system can be configured to identify one or more areas with highly saturated product participation and recommend targeting such areas for enrollment or throttling targeting of such areas. In other examples, the system can be configured to identify one or more areas with low engagement, despite density levels, and recommend targeting such areas for enrollment or throttling targeting of such areas.

In some examples, the system can be configured to transform the analyzed GIS data based on the additional weighted variables into transformed data predictive of optimal communication strategies for providing education and awareness of the insurance products and boosting engagement and ultimately employee enrollment in various products and/or a particular product. For example, the system can recommend steps for tailoring communications, such as email and text messages, to increase enrollment such as overall enrollment, enrollment of one or more predetermined products, enrollment corresponding to one or more demographics, etc. for multiple locations or a particular location, such as a priority location including for example a candidate facility and/or a required facility.

The following is an example of GIS data analysis, and more particularly, GIS Location-Allocation Analysis.

### Inputs:

Facility Type
   Candidate
      For purposes of this example, a candidate facility is a facility that may be part of the solution.
   Required
      For purposes of this example, a required facility is a facility that must be part of the solution.
Weight
   The relative weighting of the facility, which is used to rate the attractiveness, desirability, or bias of one facility compared to another.
Capacity
   This property specifies how much weighted demand the facility is capable of supplying. Excess demand won't be allocated to a facility even if that demand is within the facility's impedance cutoff.
Travel Cost Attributes
   Travel costs in time, distance, and dollar per unit of distance can be assigned with cutoff values.

The system can be configured to analyze the GIS data and then transform the analyzed GIS data based on additional weighted variables, such as demographics, engagement levels, and/or regional data into transformed data predictive of optimal locations where enrollments should take place, for how long, how many enrollers per location, and which products to promote or not, among other things.

For example, in an exemplary embodiment, additional weighted variables such as facility capacity, location priority, and/or employee engagement levels are utilized by the system to determine the optimal location for enrollers (or groups of enrollers) to service the largest populations in the most efficient way. The system can be configured to provide other predictions or recommendations such as date, timing, duration, etc. (e.g., once per year open enrollment, throughout the year, duration of enrollment), expected number of enrollments at a particular location, during a particular timeframe, etc.

The following is another example of GIS data analysis, and more particularly, GIS Location-Allocation Analysis.

County Public Schools Example:
42,531 Employees
   Includes the location where an employee works
479 work locations
Location-Allocation Analysis
   Method of analysis is to maximize attendance with fewest facilities
   Required facilities
   Ranking or weighting of facilities
   Facility capacities
   Travel time cut offs of 10, 20, 30 minutes
Output
   15 facilities identified with total number of employees of a client assigned to the facilities
   Enroller assigned to one of the 15 locations
   Drive time if applicable for that enroller
   Employee demographic summary by facility

The system can be configured to analyze the GIS data and transform the analyzed GIS data to predict or recommend the number of enrollers needed, type of enroller needed, sessions scheduling and enrollment period scheduling based on enrollment rates of current products, new products, and employee demographics.

In operation, the exemplary embodiments of the invention can be utilized for an enrollment process to predict and/or provide recommendations for allocation of enrollers to enrollment locations or facilities, as well as to identify gaps and opportunities in a customer's approach to designing or enhancing benefit programs, executing engagement campaigns, and/or providing overall education and awareness of the insurance products for educating employees of a client about the benefit(s) available and/or how to better utilize the benefits, among other things. For example, the system can be configured to receive and analyze data, such as real-time data, historical data, etc. representing what coverage is enrolled in by age, gender, by location, by dependents, by job title, and/or by union group or affiliation (if made available), among other things. The system can be configured to analyze the data, for example, to identify what line of coverage is being enrolled by which demographic and transform the analyzed data into one or more predictions or recommendations to a customer for enhancing benefits, improving overall engagement or education strategy for educating employees about the benefit(s) available or educating employees how to better utilize the benefits.

For example, based on the available data received, the system can be configured to analyze and transform data with regard to location, age, union and coverage enrolled to identify various locations having similar or dissimilar enrollment participation or potential opportunities for improvement, predict a location or locations for a targeted campaign on the benefits available, and recommend a targeted enrollment strategy at said location to promote or improve engagement and education of employees and assist with helping them get enrolled and/or utilize the benefits.

The exemplary system can be configured to receive enrollment data before open enrollment (OE) starts and enrollment data post OE to thereby perform a holistic view of the enrollment data before OE starts and post OE to identify any marked changes in the enrollment by segment, location, demographic or by line of coverage to output a comparison and show the results during OE for post open enrollment evaluation, and provide recommendations for improving and/or enhancing the overall OE process.

In another example, the system can be configured to analyze and transform data received based on the weighted variables to provide recommendations related to assigning an enroller relative to employees' home addresses to provide a lower average drive time (e.g., a lowest average drive time) for a population in a geographic region.

In other examples, based on the data received, the system can be configured to analyze and transform data received based on the weighted variables to provide recommendations for strategic locations of open enrollment hubs or sites in order to maximize the overall engagement so members can take advantage of learning about product or benefits.

In some examples, one or more of the weighted variables can be assigned a threshold value (e.g., an upper and/or lower threshold value). The system can be configured to analyze and transform the data received based on a threshold value of one or more of the weighted variables to provide the recommendations, rank the recommendations, and/or identify candidate and/or required locations to be included in the recommendations. The threshold value or values (e.g., an upper and/or lower threshold value) of one or more of the weighted variables can be assigned, for example, based on historical knowledge, expertise, and/or archive data.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 shows an example of an operating environment according to an exemplary embodiment of the invention;

FIG. 2 shows an example of inputs used to develop a predictive machine learned model, according to an exemplary embodiment of the invention;

FIG. 3 shows another example of inputs used to develop a predictive machine learned model, according to an exemplary embodiment of the invention;

FIG. 4 shows another example of inputs used to develop a predictive machine learned model, according to an exemplary embodiment of the invention;

FIG. 5 shows another example of inputs used to develop a predictive machine learned model, according to an exemplary embodiment of the invention;

FIG. 6 shows an example of communications strategy recommendations generated by the predictive machine learned model, according to an exemplary embodiment of the invention;

FIG. 7 shows an example of enroller staffing recommendations generated by the predictive machine learned model, according to an exemplary embodiment of the invention;

FIG. 8 shows an example of a process of generating enroller staffing recommendations, according to an exemplary embodiment of the invention;

FIG. 9 shows an example of a process of generating communications strategy recommendations, according to an exemplary embodiment of the invention; and

FIG. 10 shows an example of a processing system, used according to an exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

For purposes of this disclosure, the terms “component”, “module”, “system,” and the like as used herein are intended to refer to a computer-related entity, either software-executing general-purpose processor, hardware, firmware and a combination thereof. For example, a component may be, but is not limited to being, a process running on a hardware-based processor, a hardware processor, an object, an executable, a thread of execution, a program, and/or a computer.

Computer executable components of the innovative technology disclosed herein can be stored, for example, at a non-transitory, computer readable media including, but not limited to, an ASIC (application specific integrated circuit), CD (compact disc), DVD (digital video disk), ROM (read only memory), storage class memory, solid state drive, floppy disk, hard disk, EEPROM (electrically erasable programmable read only memory), or any other storage device, in accordance with the claimed subject matter.

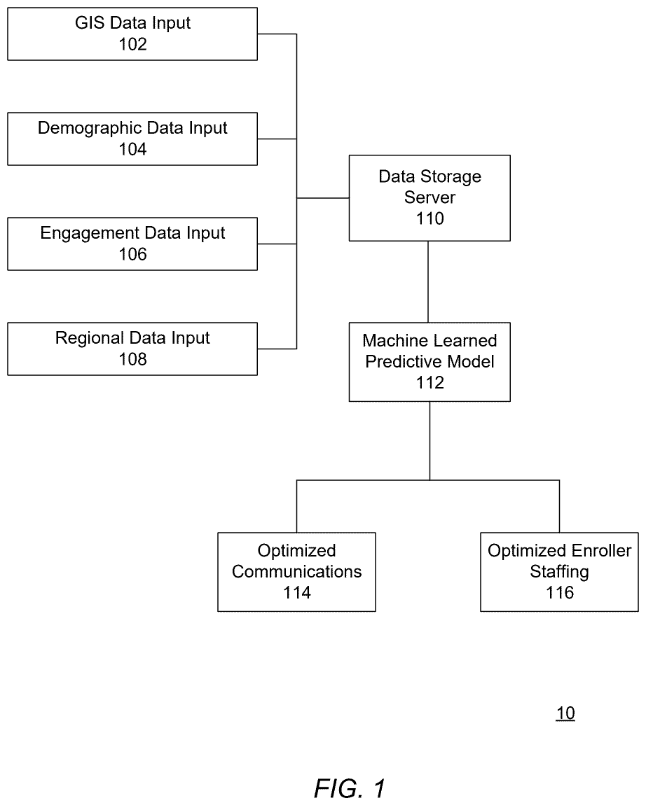

Referring now to the drawings, FIGS. 1-10 illustrate exemplary embodiments of a system for and method of optimizing user interaction for insurance enrollments, and more particularly, to a system and method of predicting optimal locations for one or more enrollers to service and optimal staffing of enrollments while reducing or minimizing costs and increasing or maximizing revenue from commissions on the insurance sales.

As shown in FIG. 1, a system 10 can include at least a GIS data input 102 and one or more of a demographic data input 104, an engagement data input 106, and a regional data input 108. A data storage server 110 or the like can be configured to receive and store data from the GIS data input 102 and one or more of the demographic data input 104, engagement data input 106, and regional data input 108.

A machine learned predictive model 112 can be configured to receive the data from the data storage server 110 or the like, analyze the GIS data input 102 and then transform the analyzed GIS data based on one or more additional weighted variables of the demographic data input 104, engagement data input 106, and/or regional data input 108 into transformed data predictive of optimized communications 114 and/or optimized enroller staffing 116. The machine learned predictive model 112 is configured to transform the analyzed GIS data 102 based on at least one weighted variable of the demographic data input 104, engagement data input 106, and/or regional data input 108, and more preferably, based on at least one weighted variable of at least two of the demographic data input 104, engagement data input 106, and/or regional data input 108, and even more preferably, based on at least one weighted variable of each of the demographic data input 104, engagement data input 106, and/or regional data input 108.

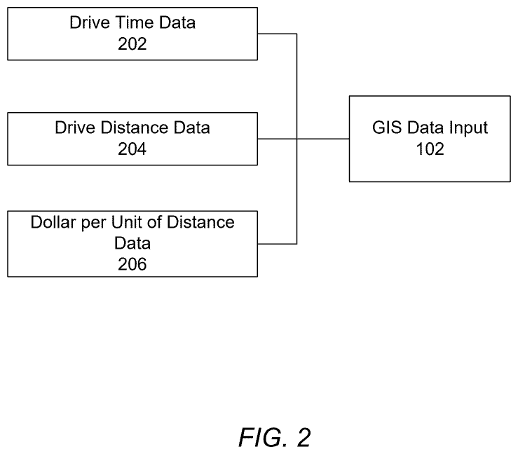

As shown in FIG. 2, the GIS data 102 can include, for example, one or more of drive time data 202, drive distance data 204, dollar per unit of distance data 206, among other data.

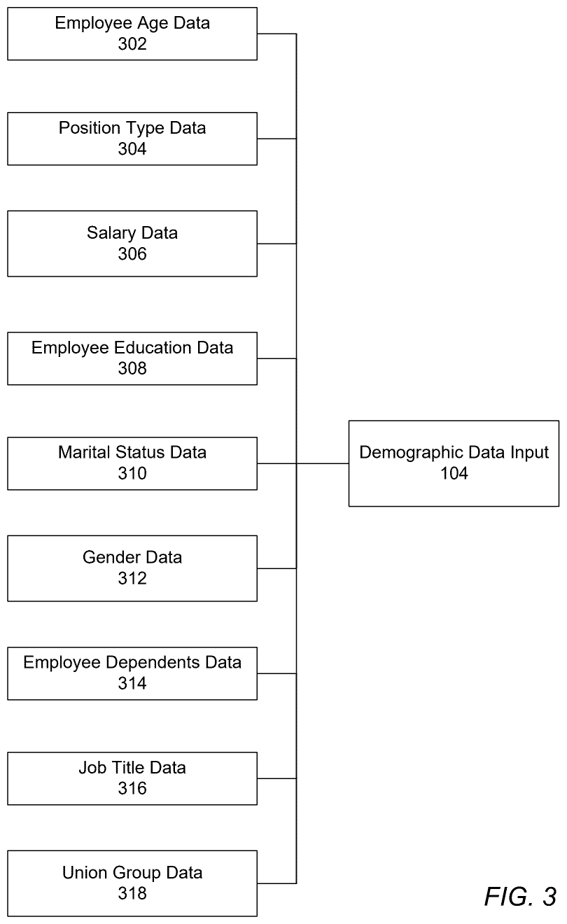

As shown in FIG. 3, the demographic data input 104 can include, for example, one or more of employee age data 302, position type data 304, salary data 306, employee education data 308, marital status data 310, gender data 312, employee dependents data 314, job title data 316, and/or union group data 318, among other data.

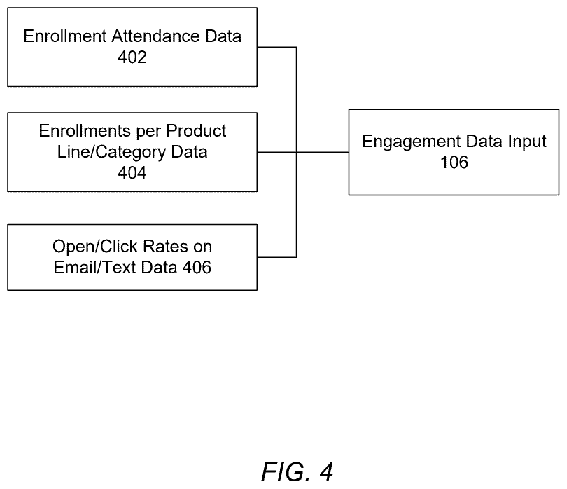

As shown in FIG. 4, the engagement data input 106 can include, for example, one or more of enrollment attendance data 402, enrollment per product line/category data 404, open/click rates on email/text data 406, among other data.

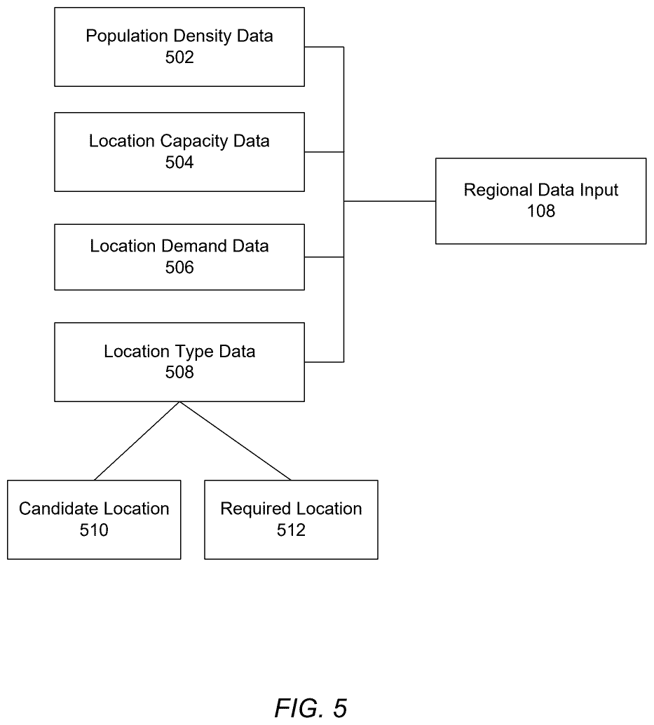

As shown in FIG. 5, the regional data input 108 can include, for example, one or more of population density data 502, location capacity data 504, location demand data 506, location type data 508, among other data. The location type data 508 can include, for example, candidate location data 510 and/or required location data 512, among other data.

A candidate location can be a location or facility that is weighted for enroller staffing, for example, based on historical data and/or prior predictions or recommendations by the machine learned predictive model 112. A required location can be a location or facility that must be included in enroller staffing, for example, based on historical data and/or prior predictions or recommendations by the machine learned predictive model 112.

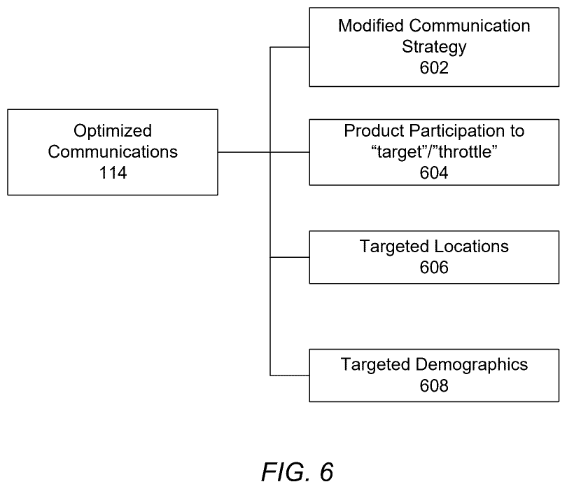

As shown in FIG. 6, the optimized communications 114 can include, for example, one or more of a modified communications strategy 602, one or more product participations to “target” or “throttle” 604, one or more targeted locations 606, and/or one or more targeted demographics 608, among other recommendations and/or predications.

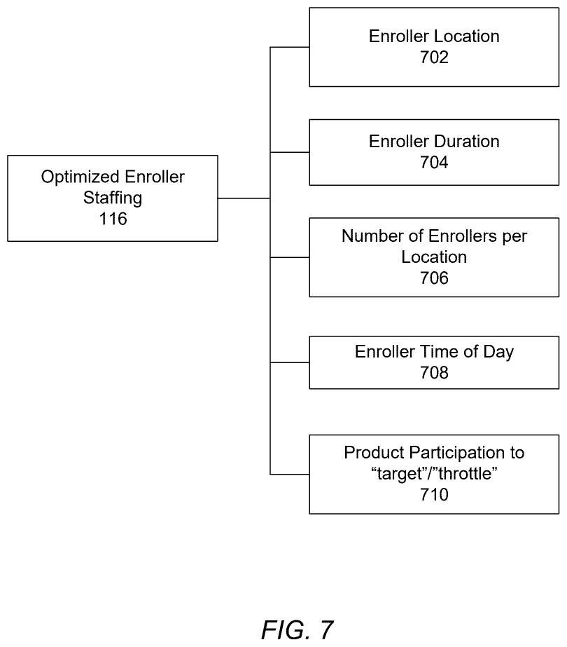

As shown in FIG. 7, the optimized enroller staffing 116 can include, for example, one or more of an enroller location 702, enroller duration 704, number of enrollers per location 706, enroller time of day 708, and/or one or more product participations to “target” or “throttle” 710, among other recommendations and/or predications.

The exemplary embodiments can transform the analyzed GIS data based on the additional weighted variables in the demographic data input 104, engagement data 106, and/or regional data input 108 to train (e.g., iteratively train) a machine learning algorithm and provide customized recommendations and predictions 114 and/or 116 to a customer (employers sponsors, or other insurance brokers). The resulting customized recommendations and predictions 114 and/or 116 can be fed, by the system, back into the demographic data input 104, engagement data 106, and/or regional data input 108 to improve the historical data.

In some examples, one or more of the weighted variables in the GIS data 102, demographic data input 104, engagement data input 106, and/or regional data input 108 can be assigned a threshold value (e.g., an upper and/or lower threshold value). The system 10 can be configured to analyze and transform the data received based on a threshold value of one or more of the weighted variables to provide the recommendations and predictions 114 and/or 116, rank the recommendations and predictions 114 and/or 116, and/or identify candidate and/or required locations to be included in the recommendations and predictions 114 and/or 116. The threshold value or values (e.g., an upper and/or lower threshold value) of one or more of the weighted variables can be assigned, for example, based on historical knowledge, expertise, and/or archive data. The threshold value or values can be fed, by the system, back into the demographic data input 104, engagement data 106, and/or regional data input 108 to improve the historical data.

In operation, the system 10 can include a non-transitory computer-readable medium including program instructions that when executed by a processor cause the processor to perform the actions of receiving the GIS data input 102 and at least one of the demographic data input 104, engagement data 106, and/or regional data input 108. The machine learned predictive model 112 can be configured to receive the data from the data storage server 110 or the like, analyze the GIS data input 102 and then transform the analyzed GIS data based on one or more additional weighted variables of the demographic data input 104, engagement data input 106, and/or regional data input 108 into transformed data predictive of optimized communications 114 and/or optimized enroller staffing 116. The machine learned predictive model 112 is configured to transform the analyzed GIS data 102 based on at least one weighted variable of the demographic data input 104, engagement data input 106, and/or regional data input 108, and more preferably, based on at least one weighted variable of at least two of the demographic data input 104, engagement data input 106, and/or regional data input 108, and even more preferably, based on at least one weighted variable of each of the demographic data input 104, engagement data input 106, and/or regional data input 108.

In an example, the machine learned predictive model 112 is configured to transform the analyzed GIS data 102 based on at least one weighted variable of the demographic data input 104, and more preferably, based on plurality of weighted variable of the demographic data input 104.

In another example, the machine learned predictive model 112 is configured to transform the analyzed GIS data 102 based on at least one weighted variable of the engagement data input 106, and more preferably, based on a plurality of weighted variables of the engagement data input 106.

In yet another example, the machine learned predictive model 112 is configured to transform the analyzed GIS data 102 based on at least one weighted variable of the regional data input 108, and more preferably, based on a plurality of the regional data input 108.

The system 10 further can be configured to ranks the recommendations and output the ranked recommendations to a customer (employers sponsors, or other insurance brokers).

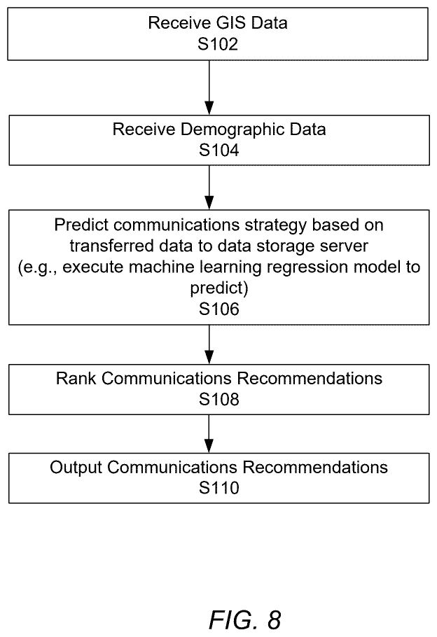

By way of example only, FIG. 8 shows an exemplary method including the steps of receiving GIS data S102, receiving demographic data S104, predicting and providing a recommendation, based on the received GIS data and demographic data and the engagement data, for a communications strategy S106 (e.g., executing a machine learning regression model, or other machine learning model utilizing one or more machine learning algorithms, to predict and provide a recommendation, based on the received GIS data and demographic data and the engagement data, for a communications strategy), ranking the communications recommendations S108, and outputting the ranked communications recommendations S110.

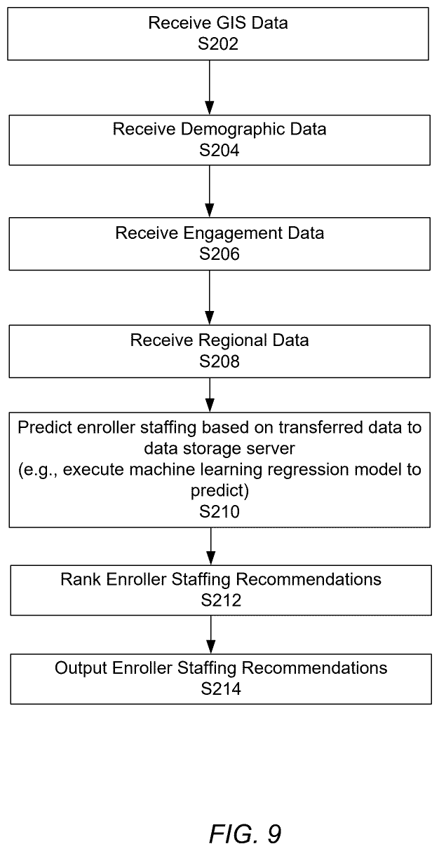

By way of example only, FIG. 9 shows another exemplary method including the steps of receiving GIS data S202, receiving demographic data S204, receiving engagement data S206, receiving regional data S208, predicting and providing a recommendation, based on the received GIS data, demographic data, engagement data, and regional data, for enroller staffing S210 (e.g., executing a machine learning regression model, or other machine learning model utilizing one or more machine learning algorithms, to predict and provide a recommendation, based on the received GIS data, demographic data, engagement data, and regional data, for enroller staffing), ranking the enroller staffing recommendations S212, and outputting the ranked enroller staffing recommendations S214.

One of ordinary skill in the art will recognize that other systems and methods having one or more of the elements described are contemplated within the spirit and scope of the invention.

The systems and methods can be configured to analyze the GIS data and then transform the analyzed GIS data based on one or more additional weighted variables into transformed data predictive of optimal locations for one or more enrollers to service and optimal staffing of enrollments. The exemplary systems and methods can be configured to utilize geoprocessing and network analysis capabilities to analyze the GIS data including, for example, analyzing and modeling transportation networks, such as road networks, and calculating transportation times, such as drive times, for enrollers from an enroller's home address to one or more facilities, between one or more facilities, etc. The systems and methods can be configured to transform the analyzed GIS data based on additional weighted variables.

The systems and methods can be configured to provide recommendations for grouping enrollers based on drive times and other variables, identifying optimal facilities for in-person consultations and providing more strategic and cost-effective enroller location recommendations, enhancing the efficiency of in-person open enrollment meetings, and boosting employee enrollment in various products and/or particular products based on the weighted variables in the demographic, engagement, and regional data 104, 106, 108, and/or one or more additional weighted variables. By transforming the analyzed GIS data utilizing, for example, predictive modeling and real-time data analysis in combination with additional weighted variables utilizing historical knowledge, expertise, and archive data, the systems and methods can be configured to output relevant, accurate, and highly effective recommendations and predictions for product offerings, quantities, design, and forecasted utilization, among other things. The exemplary system can identify and/or rank one or more facilities, for example, by priority or importance, and/or as a candidate facility or as a required facility for in-person enrollment.

The exemplary systems and methods can output the recommendations and predictions 114 and/or 116 to the customer in a variety of ways. For example, the recommendations and predictions 114 and/or 116 can be output in a table, chart, graph, map, or other visual or graphical representation. Additionally or alternatively, the recommendations and predictions 114 and/or 116 can be output in text form and/or accompanied by a summary of the recommendations and predictions 114 and/or 116, a ranking of one or more of the recommendations and predictions 114 and/or 116, a categorized or category specific output of the recommendations and predictions 114 and/or 116, or the like.

In other examples, the systems and methods can utilize ChatGPT or other generative AI technologies to develop and provide customized recommendations to customers based on the outputs, including rankings and/or categories of such recommendations. For example, one or more additional modules can be provided to input the predictions and/or recommendations provided by the machine learned predictive model 112 into ChatGPT or another generative AI technology to develop and provide a customized recommendation to a customer.

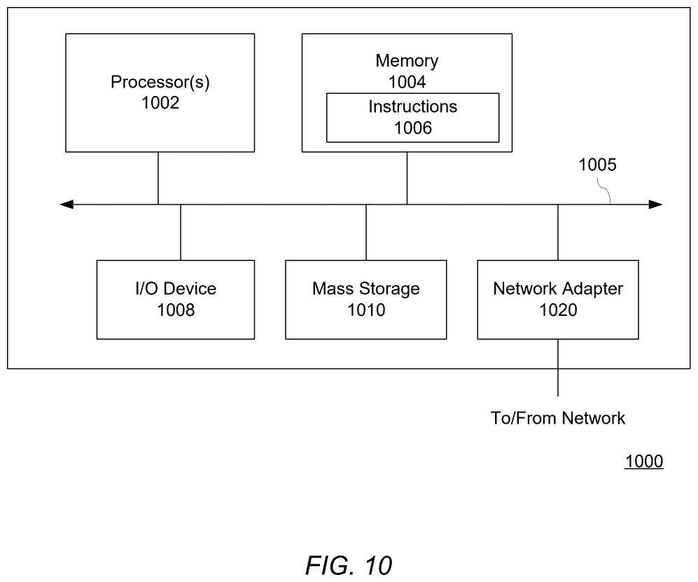

FIG. 10 illustrates a high-level block diagram showing an example of the architecture of a processing system 1000 that may be used according to embodiments described herein. Note that certain standard and well-known components which are not germane to the present embodiments are not shown. The processing system 1000 includes one or more processor(s) 1002 and memory 1004, coupled to a bus system 1005. The bus system 1005 shown in FIG. 10 is an abstraction that represents any one or more separate physical buses and/or point-to-point connections, connected by appropriate bridges, adapters and/or controllers. The bus system 1005, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”). The processor(s) 1002 are the central processing units (CPUs) of the processing system 1000 and, thus, control its overall operation. In certain aspects, the processors 1002 accomplish this by executing software stored in memory 1004. A processor 1002 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices. Memory 1004 represents any form of random access memory (RAM), read-only memory (ROM), flash memory, or the like, or a combination of such devices. Memory 1004 includes the main memory of the processing system 1000. Instructions 1006 implement the process steps of FIGS. 8 and 9 and data structures described above may reside in and execute (by processors 1002) from memory 1004. Also connected to the processors 1002 through the bus system 1005 are one or more internal mass storage devices 1010, and a network adapter 1012. Internal mass storage devices 1010 may be or may include any conventional medium for storing data in a non-volatile manner. The network adapter 1012 provides the processing system 1000 with the ability to communicate with remote devices (e.g., storage servers, application programming interfaces) over a network and may be, for example, an Ethernet adapter, a Fibre Channel adapter, or the like. The processing system 1000 also includes one or more input/output (I/O) devices 1008 coupled to the bus system 1005. The I/O devices 1008 may include, for example, a display device, a keyboard, a mouse, etc.

The present invention has been described herein in terms of several preferred embodiments disclosed herein; however, it should be understood that the enclosed embodiments are merely examples and that the systems and methods described below can be used in numerous forms. Thus, specific structural and functional details disclosed in this specification should not be construed as limiting but merely are a basis for the claims as a representation basis for teaching one of skill in the art how to use the invention with an appropriate structure and function. Moreover, the terms and phrases used are not intended to be limiting, but instead are intended to provide an understandable description of the invention. Accordingly, the description of the present invention is presented for purposes of illustration and description but is not intended to be exhaustive or limited to the embodiment of the invention herein disclosed. Many modifications and variations will be apparent to those of skill in the art once they have reviewed this specification without departing from the scope and spirit of the invention. The embodiment was chosen and described to explain the principles of the invention and the practical application, and to enable others of skill in the art to understand the invention for various embodiments with various modifications as are suited to the particular use contemplated. The terminology used herein is for the purpose of describing particular embodiments only and is not intended to limit the invention.

What is claimed is:

1. A non-transitory computer-readable medium including program instructions that when executed by a processor cause the processor to perform the following actions:
receive GIS data;
receive at least one of demographic data and engagement data;
predict and provide a recommendation, based on the received GIS data and the at least one of the demographic data and the engagement data, for at least one of enroller staffing and a communications strategy.

2. The non-transitory computer-readable medium of claim 1, wherein the program instructions when executed by the processor cause the processor to perform the following additional actions:
ranking the recommendations; and
outputting the ranked recommendations.

3. The non-transitory computer-readable medium of claim 1, wherein the program instructions when executed by the processor cause the processor to perform the following actions:
receive the demographic data and the engagement data; and
predict the at least one of the enroller staffing and the communications strategy based on the received GIS data, the demographic data, and the engagement data;
ranking the communications recommendations; and
outputting the communications recommendations.

4. The non-transitory computer-readable medium of claim 1, wherein the program instructions when executed by the processor cause the processor to perform the following actions:
receive the demographic data, the engagement data, and regional data; and
predict the at least one of the enroller staffing and the communications strategy based on the received GIS data, the demographic data, the engagement data, and the regional data;
ranking the communications recommendations; and
outputting the communications recommendations.

5. A system for optimizing user interaction for insurance enrollments, the system including the non-transitory computer-readable medium of claim 1.

6. A method of optimizing user interaction for insurance enrollments, the method comprising the steps of:
receiving GIS data;
receiving at least one of demographic data and engagement data;
predicting, based on the received GIS data and the at least one of the demographic data and the engagement data, at least one of an enroller staffing and a communications strategy.

7. The method of claim 6, further comprising the steps of:
ranking the recommendations; and
outputting the ranked recommendations.

8. The method of claim 6, further comprising the steps of:
receiving the demographic data and the engagement data; and
predicting, based on the received GIS data, the demographic data, and the engagement data, the at least one of the enroller staffing and the communications strategy;
ranking the communications recommendations; and
outputting the communications recommendations.

9. The method of claim 6, further comprising the steps of:
receiving the demographic data, the engagement data, and regional data; and
predicting, based on the received GIS data, the demographic data, the engagement data, and the regional data, the at least one of the enroller staffing and the communications strategy;
ranking the communications recommendations; and
outputting the communications recommendations.

10. The non-transitory computer-readable medium of claim 1, wherein the program instructions when executed by the processor cause the processor to perform the action of predicting and providing the recommendation by executing a machine learning regression model.

11. The method of claim 6, wherein the step of predicting is performed by executing a machine learning regression model by a non-transitory computer-readable medium including program instructions that when executed by a processor cause the processor to perform the step of executing the machine learning regression model.
